(19) United States
(12) Patent Application Publication
(10) Pub. No.: US 2004/0106396 A1
(43) Pub. Date: Jun. 3, 2004

(54) Method for distributing customized data for mobile telephone network

(76) Inventors: Fabrice Segura, Meyzieu (FR); Djellali Mokhtari, Paris (FR)

Correspondence Address: CANTOR COLBURN, LLP, 55 GRIFFIN ROAD SOUTH, BLOOMFIELD, CT, 06002

(21) Appl. No.: 10/399,568

(22) PCT Filed: Oct. 17, 2001
(86) PCT No.: PCT/FR01/03218

(30) Foreign Application Priority Data
Oct. 18, 2000 (FR) 00/13423

(51) Int. Cl. H04Q 7/20

(52) U.S. Cl. 455/414.1; 455/466

(57) ABSTRACT

The invention concerns a method for distributing customized data in the form of text messages to users of a mobile telephone network (4). Said method uses multicast (Cell Broadcast) functions specific to said networks, but enables customization of effectively available information for the terminal user, and control by the service operator of access to said information, in particular for marketing and billing to the final user. To achieve this, the method uses encryption of the broadcast information (1), and its decryption on the mobile telephone (5), with a software which thereby manages access to the information (1). The encryption keys are stored by the operator, either in the mobile telephone (5), or in the SIM card, and in all cases, outside the reach of the user.

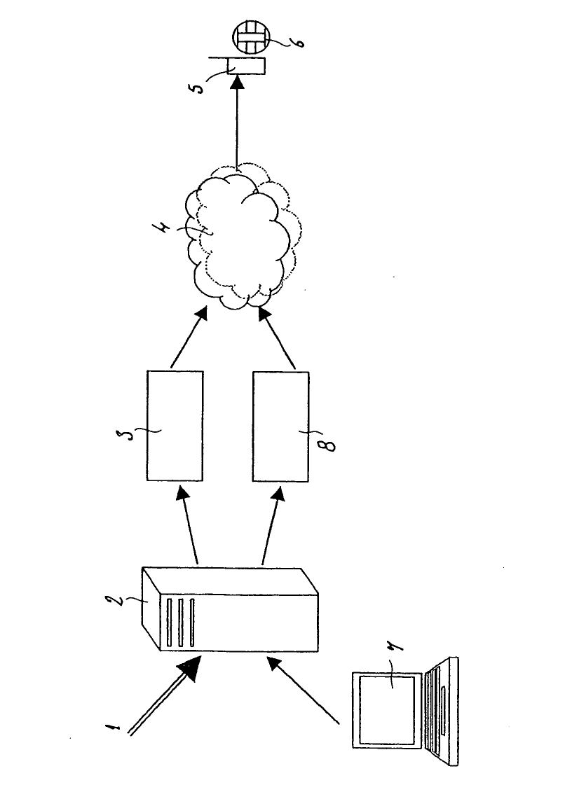

The present invention relates to a method for broadcasting “customized” information in the form of text messages to users of a mobile telephone network. This method uses multicast (Cell Broadcast) functions specific to these networks but enables customization of the information actually available for the user of the terminal, and enables the service operator to control access to this information, in particular for the purposes of marketing and billing to the end user.

“Text” information can be broadcast in a mobile telephone network by sending short messages (SMS). The SMS messages are transmitted for a single recipient mobile telephone. If the same message needs to be transmitted to a number of users, as many SMS messages must be transmitted, which is not viable if the message has to be received by a large number of subscribers due to capacity limitations of mobile telephone networks in conveying such traffic.

Mobile telephone networks support another method for sending messages to mobile terminals: Cell Broadcast, which enables the same message to be sent to all mobile telephones in a cell or to all mobile telephones in a network simultaneously. However, there is no way to control access to this information. It is therefore not possible to use this method to transmit an item of information reserved for a restricted population of subscribers.

Finally, from the document GB A 2327567 a method is already known which simultaneously uses a broadcast of messages by Cell Broadcast, encryption of the information broadcast, and its decryption on the telephone by software which thereby manages access to the information. However this method exhibits a certain number of drawbacks, in particular the use of encoding techniques that are not very secure, the transmission of encryption keys over the network, the lack of a traceability mechanism for operations, and the difficulty of implementation since this method requires modifications to certain network equipment.

The present invention aims to perfect such a method by improving, in particular, the encryption technique for controlling access to the information broadcast, and security.

To this end, the subject of the invention is a method for broadcasting “customized” information in the form of text messages to users of a mobile telephone network with simultaneous use of Cell Broadcast multicast functions for the broadcast, encryption of the information broadcast, and its decryption on the telephone by software which thereby manages access to the information, which method is essentially characterized in that the keys of said encryption are stored by the operator, either in the mobile telephone, or in the SIM card, and in all cases out of the user's reach.

Thus the method of the invention uses encryption of information before it is transmitted in multicast mode, and decryption of the information by means of software on the mobile telephone, using “strong” encryption techniques in which the encryption keys are not accessible to users. All the users of the mobile telephone network will potentially be able to configure their telephone so as to receive these messages, but will not as a result have access to the information.

The list of information that this software decrypts and makes available to the user can be configured remotely by the sending of another message, also encrypted, containing in particular the list of information to be decrypted. Each user of the service who wants to “subscribe” to the information broadcast, or to modify the conditions of their subscription (access to other information), must do so via a computer system managed by the operator, and this will enable billing of the information to which the user will have subscribed.

Tracking functionalities, for SMS messages, and in particular acknowledgement of their actual delivery to the mobile telephone, can be used to check that the configuration information is received correctly and ensure that the billing of access to information will actually reflect that which will be received by the user.

This method, which relies only on the use of standardized mechanisms of GSM and UMTS networks, or a computer system external to this network, and software on the SIM card of terminals, can be used to offer “a la carte”, and subscription-based, information services to millions of users simultaneously, when an individual-based mailing, using SMS messages, can no longer be used for this purpose because of network bandwidth limitations.

The accompanying drawing illustrates the invention. With reference to the single FIGURE of this drawing, the method proposed by this invention to solve this problem is as follows:

Each of the information messages (1) which have to be broadcast by this method is transmitted on one of the Cell Broadcast “channels” via the CBC (Cell Broadcast Center) (3) of the network by a computer system (2) managed by the operator, which encrypts these messages using a “strong” encryption method such as the DES method. All users of the mobile telephone network (4) will potentially be able to configure their mobile telephone (5) so as to receive these messages, but will not as a result of this have access to the information. In this case, in particular, the type of mobile telephone (5) concerned is one with a “SIM card” (6), as specified later.

Each user of the service (7) who wants to subscribe to the information broadcast, or wants to modify the conditions of their subscription (access to other information) must do so via the same computer system (2) managed by the operator.

When the new conditions are registered (in particular the list of information items to which the user is subscribed), this system (2) will upload, via the SMSC (Short Message Service Center) (8) of the network, the choices of the user to his telephone (5) by sending an SMS message (which will be called “configuration SMS”). This SMS message will be encrypted in the same way as the information messages, to make it impossible for anyone except the service operator to modify the list of messages which are authorized to be received.

Tracking functionalities for SMS messages, and in particular acknowledgement of their actual delivery to the mobile telephone (5), can be used to check that the configuration information is correctly received and that the telephone has correctly registered these new conditions. Hence this will ensure that the billing of access to information will actually reflect that which will be received by the user.

This SMS message will be decrypted and interpreted by software installed in the mobile telephone (5). This software may be an application on a smartcard or “SIM card” (6) in the case of GSM or UMTS networks, or it must be integrated with the software embedded in the telephone, when it is built, for PCS networks.

The software in question on the telephone will decrypt all the Cell Broadcast messages received by the telephone and to which the user will have subscribed, according to the instructions received previously in the configuration SMS. It will alert the user when messages are received (by a beep for example), and will allow the user to read them.

In the case of GSM and UMTS networks, in which the terminals are equipped with a SIM card (6), the method of implementation is as follows:

The abovementioned software is integrated in the SIM card. The dialog between a terminal and its SIM card, described in ETSI standards GSM 11.11 and 11.14, enables the card to receive SMS messages specifically intended for it (the procedure, described in ETSI standards GSM 03.38 and 03.40, consists in sending a Class 2 message). When an SMS message is received, a computer process can be initiated on the card, and this process will therefore involve the chip setting “wait to receive” conditions for all the Cell Broadcast channels corresponding to the desired configuration.

These same standards specify that the SIM card also receives all the Cell Broadcast messages, if they are also Class 2, and if they are sent on one of the channels for which the SIM card has requested reception by setting the channel numbers in the EF CBMID register, which is carried out in the previous step.

When a message is received, the software on the SIM card alerts the user (typically with a beep), stores the message and makes it available to the user in one of the additional menus of the telephone, operated via the software installed on the SIM card. The aggregation functionalities of Cell Broadcast messages enable messages of 82*15=1230 bytes to be sent. Use of compression algorithms such as the one described in standard GSM 03.42 enables even longer messages to be sent.

It is to be noted that all the operations of the method are either supported by the standardized mechanisms of GSM and UMTS networks, or carried out by a computer system external to this network or the software on the SIM card (6) of the terminals (5).

Protection of the method is ensured by the use of configuration SMS messages and Cell Broadcast messages, the contents of which are encrypted beforehand, in accordance with the possibilities offered by current legislation. The encryption keys used are stored in the computer system of the service operator, and either in the SIM card (6) or in the mobile telephone (5), and in all cases out of the user's reach. These keys do not form part of a transmission that can be intercepted.

This method can be used to offer “a la carte”, and subscription-based information services to millions of users simultaneously, when an individual-based mailing, using SMS messages, can no longer be used for this purpose because of network bandwidth limitations.

The procedures described above apply also to a PCS network if software with identical functionality is installed directly in the mobile telephone when it is built, due to lack of smartcards in terminals for this type of network.

1. A method for broadcasting “customized” information in the form of text messages to users of a mobile telephone network (4) with simultaneous use of Cell Broadcast multicast functions for the broadcast, encryption of the information (1) broadcast, and its decryption on the mobile telephone (5) by software which thereby manages access to the information, which method is characterized in that the keys of said encryption are stored by the operator, either in the mobile telephone (5), or in the SIM card (6), and in all cases out of the user's reach.

2. The method as claimed in claim 1, characterized in that said decryption is performed by software on the mobile telephone (5) that can be configured remotely by the sending of another encrypted message containing, in particular, the list of information to be decrypted.

3. The method as claimed in claim 2, characterized in that tracking functionalities, for SMS messages, and in particular acknowledgement of their actual delivery to the mobile telephone (5), can be used to check that the configuration information is received correctly.

4. The method as claimed in any of claims 1 to 3, characterized in that, in the case of GSM and UMTS networks, with terminals (5) equipped with a SIM card (6), the Cell Broadcast messages that are broadcast in order to be processed by the SIM card are broadcast in the form of Class 2 messages according to the procedure described in the GSM and UMTS network standards.

5. The method as claimed in any of claims 1 to 4, characterized in that all the operations of the method are either supported by the standardized mechanisms of GSM and UMTS networks, or carried out by a computer system external to this network or the software on the SIM card (6) of the terminals (5).
